(19) United States
(12) Patent Application Publication
(10) Pub. No.: US 2018/0079342 A1
(43) Pub. Date: Mar. 22, 2018

(54) Beverage Container Holder for Mounting to the Exterior of a Vehicle

(71) Applicant: Scott Douglas Cavallo, Healdsburg, CA (US)

(72) Inventor: Scott Douglas Cavallo, Healdsburg, CA (US)

(21) Appl. No.: 15/470,070

(22) Filed: Mar. 27, 2017

Related U.S. Application Data
(60) Provisional application No. 62/313,728, filed on Mar. 26, 2016.

(51) Int. Cl. B60N 3/10

(52) U.S. Cl. CPC B60N 3/101; B60N 3/105

(57) ABSTRACT

A beverage container holder of rigid construction for mounting to an exterior of a vehicle for receiving and retaining a beverage container, having an off-set feature and a mount enabling the holder to be mounted at a preferred height and location while avoiding obstructions that are features of vehicle.

### CROSS REFERENCE TO RELATED APPLICATION

This application claims the benefit of provisional application No. 62/313,726 Filed on Mar. 26, 2016

### BACKGROUND

In many instances, the U.S. Department of Labor requires employers to provide employees potable drinking water in amounts that are adequate to meet the health and personal needs of each employee. The employer is further required to provide the water in covered containers with single-use drinking cups stored in sanitary receptacles. States have promulgated similar rules. Many construction, field, and other laborers work off site. As a result, the employer must haul potable water in covered containers with single use cups to each worksite. The employer must also make the water readily available to the worker throughout the day. Compliance with these laws is often accomplished by mounting a beverage container holder onto a work truck. There are a variety of beverage container holders designed to mount on utility trucks.

There are factors which limit where beverage container holders may be mounted. First, workers must have access to the portable beverage container, i.e., they must be able to dispense the beverage from the container throughout the work day. This means that the beverage container holder is typically mounted the exterior of the truck such that a worker can easily dispense the beverage from outside of the truck. Next, a typical utility truck has utility boxes, and other utilities mounted to the truck. The beverage container holder must be mounted such that it doesn't interfere with the utility of the truck. Lastly, the utility truck must comply with DMV standards such that the beverage container does not over protrude from the side of the truck; or cover the break or tail lights. Thus, there are limited locations on a utility truck where the beverage container holder may be mounted practically and legally mounted.

The ideal location for mounting a beverage container holder is on a rear facing panel of a utility truck. However, many utility trucks with service bodies have racks mounted to the rear facing panels. In addition, the tail and break lights are often on the rear facing panels. The rear rack legs extent down along the rear facing panel, and protrude. A variety of beverage container holders are mounted to the rear rack legs where the legs protrude because it is at an ideal height, it doesn't cover the break or tail lights and doesn't interfere with the utility of the truck.

A particular type of holder, as shown in FIG. 5, that is mounted to a rear rack leg, has a sheet metal mount, a sheet metal base that is at a right angle to the sheet metal mount, and one or more flexible straps for securing a portable beverage container to the holder. The sheet metal tends to bend under the weight of a full container. A portable beverage container, such as the type produced by Igloo® Products, Inc., has a volume of 5 gallons, weighing approximately 40 pounds when full. After a relatively short amount of use, the sheet metal mount and base bend under the weight and no longer support the beverage container, such that the beverage container rides at an awkward tilt. Often the sheet metal mount is situated such that it unintentional bends at the base of the rear rack leg further exacerbating the tilt. The holder cannot be attached to the panel below the rear rack leg because the rear rack leg protrudes such that the portable beverage container cannot be placed in the holder. Even if the holder can be placed lower on the panel, it often blocks the view of the tail or break lights or is too low for the workers to conveniently access the beverage spout at the base of the portable beverage container.

In addition, several beverage container holders including the holder discussed above have flexible straps for securing the beverage container to the holder. The environment in which the beverage container exists is harsh. The beverage container is mounted to a truck that is outside in the weather all day exposed to UV light, moisture, wind, and dirt. The straps often break or are lost. The container is often further stressed by workers putting additional force on the beverage holder by stepping-on, pulling-on, lean-on or otherwise impacting the beverage container holder. Other, beverage container holders are made of materials that struggle to withstand the stress of the utility truck environment.

### SUMMARY

A beverage container holder having features of the present invention includes a cage for retaining a beverage container, with an open top for receiving the beverage container. The arms connect the cage to a mount plate allowing the cage to be mounted offset from a truck or a feature of a truck. The arms allow the cage to be mounted in additional locations because they allow the cage to be mounted away from obstructions on the truck. The cage may be configured such that it is shorter than a beverage container. The height difference enables the beverage container extends beyond an obstruction that would otherwise interfere with the cage or mounts.

In a particular embodiment, there are four arms, two joined to the upper band and parallel to each other. The other two joined to the lower band and parallel to each other. All of the arms are the same length and are joined perpendicular to a mounting plate. The offset between the mounting plate and the cage is such that the beverage container holder may be mounted directly under a rack arm, where the top portion of the beverage container extends out of the cage and along the rack arm.

Another feature of the invention is durability. In a particular embodiment, the cage is constructed with two bands, an upper band and lower band both forming a permanently closed circle. The upper band and lower bands function to limit the side-to-side motion of a beverage container. In addition, the solid construction, two-band system adds durability and strength to the cage. The two bands are held in place by the supports, which may be metal straps. Where a metal strap is used, the metal strap is joined at one end to the upper band and at the other end to the lower band. The supports are dispersed around the bands such that the bands are optimally supported. Ideally the straps would be equally spaced around the bands. An addition, set of straps may be used to construct a base. Ideally, two straps would dissect the base of the lower band. Each strap joined to opposite sides of the lower band and equally spaced relative to the other, ideally, dissecting the base area of the lower band into thirds.

In a particular embodiment, all of the components of the cage and arms are constructed of a rigid material, such as 3/16 inch thick, at least 1 inch wide mild steel that will not break or easily corrode when used in the harsh conditions that a utility truck exists.

### DESCRIPTION OF THE DRAWINGS

These features, aspects, and advantages of the present invention will become better understood with regard to the following description, appended claims, and accompanying drawings where:

FIG. 1 shows a side view of a preferred embodiment of the invention;

FIG. 2 shows a partial side view of a preferred form of the invention;

FIG. 3 shows a view of the base of a preferred embodiment of the invention;

FIG. 4 shows a side view mounted to a utility truck (the truck is not a feature of the invention) illustrating the advantage of mounting the beverage container holder at an offset; and

FIG. 5 Shows a side view of the prior art mounted to a utility truck illustrating the weakness of the structure and the limited mounting capacity.

### DETAILED DESCRIPTION

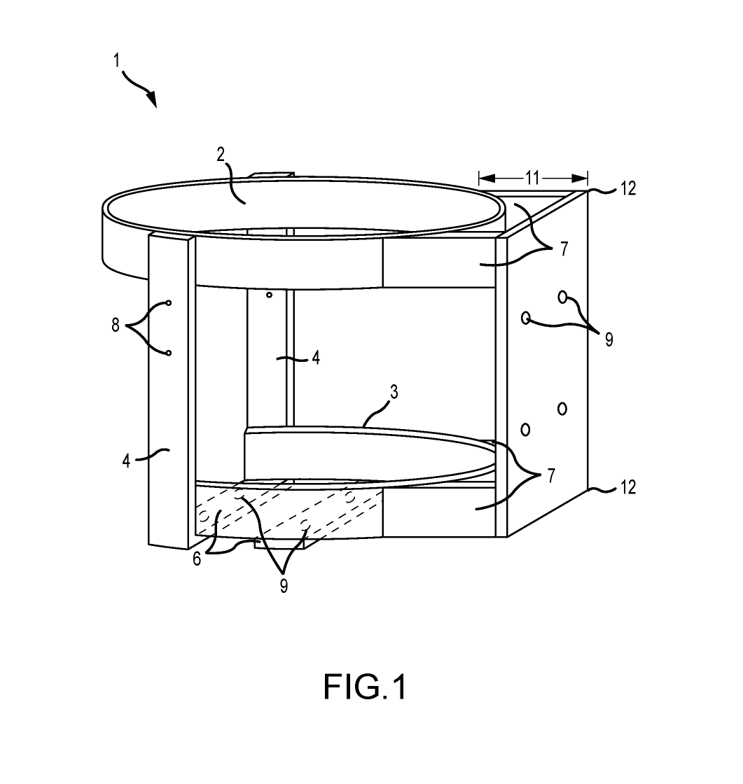

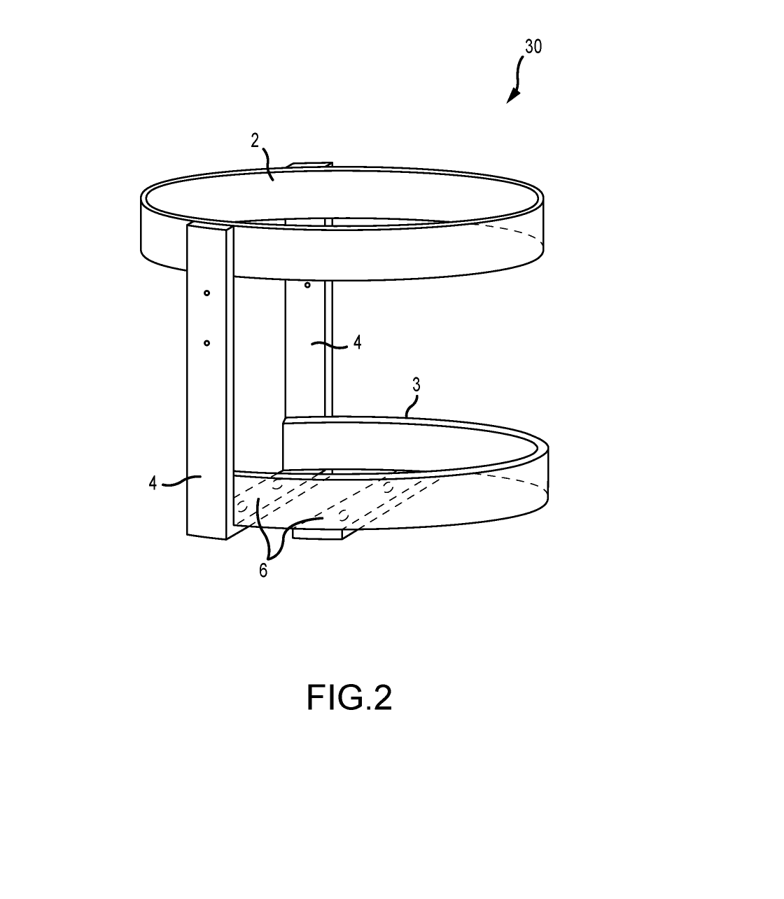

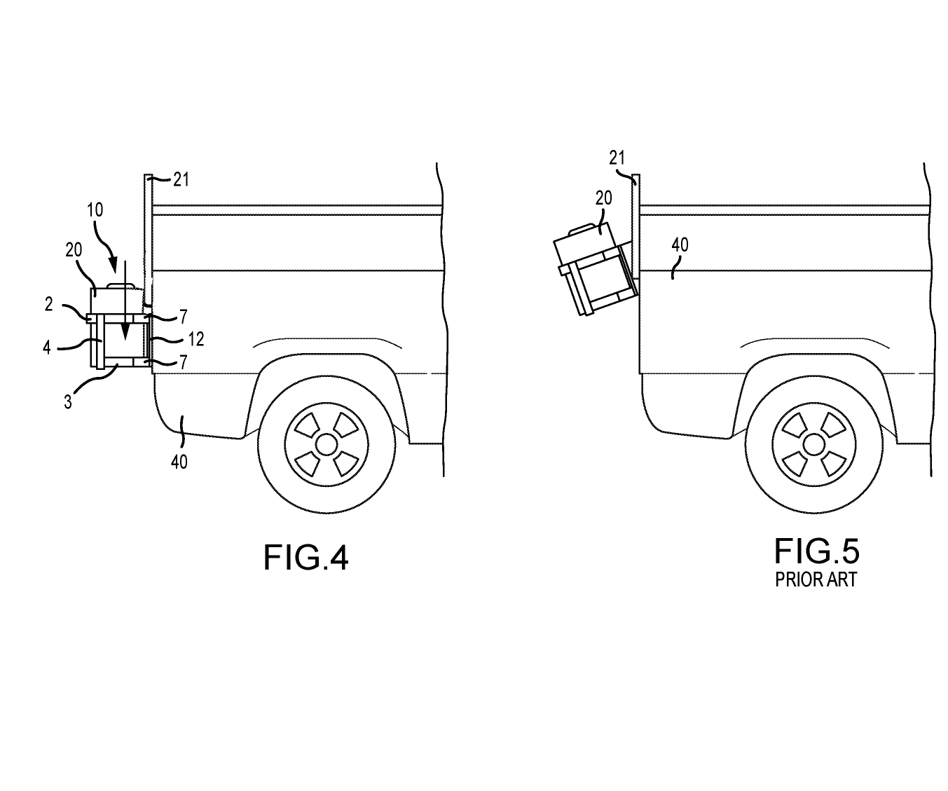

As depicted in FIG. 1, a particular embodiment of the beverage container holder 10, comprises two arms 7 independently joined to the lower band 3 and mounting plate 12, connecting the cage 30 to the mounting plate 12, and two arms 7 independently joined to the upper band 2, further connecting the cage 30 (as shown in FIG. 2) to the mounting plate 12. This arrangement has the benefit of allowing the cage 30 to be mounted at an offset 11 from a truck (as depicted in FIG. 4) or a feature of a truck. The truck is not a feature of the invention. It is shown only for illustrative purposes. The arms 7 may be joined by welding where the arms are metal. The arms 7 are arranged parallel to each other and perpendicular to the cage 30 and the mounting plate 12. This arrangement is beneficial for ensuring that the beverage container 20 sits upright. However, it is conceivable that the arms 7 are joined at an angle other than 90 degrees in relationship to the cage 30 such that the beverage container 30 is held on a tilt. A off-90-degree relationship may be desired such that the beverage container holder 10 fits in a certain location that it would not be possible with a 90-degree relationship. The rigidity, discussed below allows the arms to relate to the cage 30 and mounting plate 12 at different angels without sacrificing durability.

In practice, a shown in FIG. 4, the cage 30 may be configured such that it is shorter than a beverage container 20. The beverage container is not a feature of the invention. It is shown for only for illustrative purposes. The height difference enables the beverage container 20 to extend beyond an obstruction that would otherwise interfere with the cage 30 or mounting plate 12. A standard 5-gallon Igloo® beverage container is 20.25 inches tall. In this instance, the ideal height of the holder is between 9 and 15 inches. These heights are not limiting. The holder could conceivable be less than 9 inches or greater than 15 inches. In addition, the holder could be configured for receiving a different size beverage container 20, such as a 10-gallon Igloo®. In this instance, the dimensions may be configured for receiving and retaining the larger beverage container 20. The relative height of the holder 10 in combination with the offset 11 between the mounting plate 12 and the cage 30, effectuated by the arms 7, allows the holder 10 to be mounted directly under a rack arm 21 (not a feature of the invention), where the top portion of the beverage container 20 extends out of the cage 30 and along the rack arm 21 (as shown in FIG. 4). There are many benefits to this arrangement: first, the holder 10 may be placed above a tail light or break light in compliance with the law; Second, the area under the rack arm 21 is often under under-utilized, thus ideal for placing the holder 10; Third, the holder 10 is very stable when the mounting plate 12 is flush with the rear panel of a truck 40, as is accomplished in this arrangement; and fourth, the beverage container 20 is at an ideal height for dispensing the beverage from the spigot.

In a particular embodiment, all of the components of the cage 30 and arms 7 are constructed of a rigid material, such as 3/16 inch thick, 1 inch wide mild steel straps that will not break or easily corrode when used in the harsh conditions that a utility truck exists. In practice, the holder 10 may be made out of a wide variety of metals including but not limited to mild steel, carbon steel, stainless steel, aluminum, cold role steel, or sheet metal. It could also conceivably be made of plastic, wood, fiberglass, carbon fiber or other material, to the extent these materials sustain a static and dynamic load of a heavy beverage container. The preferred embodiment, however, is mild steel because of its strength, cost, durability, and usability.

As shown in FIG. 4, a particular embodiment the cage 30 is constructed with two bands, an upper band 2 and lower band 3 both forming a permanently closed circle. However, where a beverage container 20 contains a spigot (not shown and not a feature of the invention) that protrudes, the lower band 3 may form a semi-circle (As shown in FIGS. 1-3) to provide room for the spigot. In the alternative, the lower band 3 may be located at a height above the spigot. In this instance a gap would exist between the lower band 3 and the base 6. The upper band 2 may also form a semi-circle so long as the opening is smaller than the diameter of the beverage container 20, such that it still fulfills its function of retaining the beverage container 20. The rigidity and strength of the design allows for semi-circle bands 2 and 3 without sacrifice. The upper band 2 and lower band 3 function to limit the side-to-side motion of a beverage container. The solid construction and two-band system adds durability and strength to the cage. The two bands 2 and 3 are held in place by the supports 4, which may be metal straps. Where a metal strap is used, the metal strap is joined by weld at one end to the upper band 2 and at the other end to the lower band 3. The supports 4 are dispersed around the bands 2 and 3 such that the bands 2 and 3 are substantially static under a load. Ideally, the supports 4 are equally spaced around the perimeter of the bands 2 and 3.

In a particular embodiment the base 6 is constructed of two metal straps that dissect the base of the lower band 3. Each base strap 6 is joined to opposite sides of the lower band 3 and equally spaced relative to the other, ideally, dissecting the base area of the lower band 3 into thirds. The two-strap base 6 as opposed to a solid base has the added feature of being sanitary, e.g., the beverage or rain that would otherwise collect in a solid base, will drain to either side of the base straps 6. A close bottom will collect water, dirt, bacteria and fungi. In addition, the base 6 provides a rigid structure while decreasing the overall weight of the holder 10. The base straps 6 may be flat such that the beverage container 20 sits flush with the base 6.

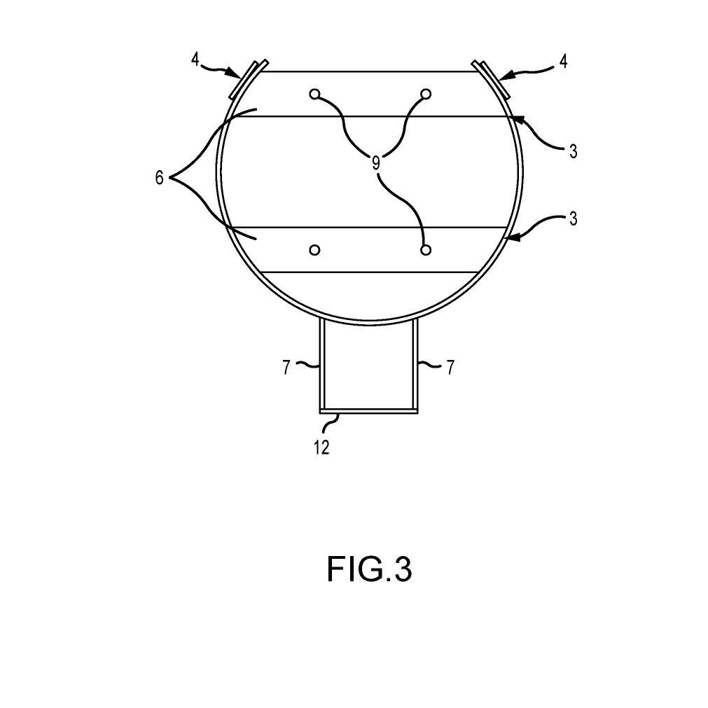

In practice, as shown in FIG. 3, the holder 10 may be constructed such that one or more arms 7, the base 6, and the supports 4 are arranged such that they are flush with the horizontal plane of the lower band 3 base. As shown, in FIG. 1, all the elements connected to the upper band 2 are flush, in the same manner with the top horizontal plane of the upper band 2.

As shown in FIG. 1, in a particular embodiment, there are a plurality of fastener installation sites 9 are for the purpose of attaching the jug holder 1 to a truck 40 (as shown in FIG. 4) or any other location necessary. There are 4 fastener installation sites 9 on the mounting plate 12. This allows for strength, stability, and longevity. There may be less or more of the fastener installation sites 9 depending on the structure the holder 10 will be mounted to. There are also fastener installation sites 9 on the base 6. This allows for flexibility in where the holder 10 may be mounted. The holder 10 may be mounted at its base, such as to a horizontal surface on the truck, one horizontal feature may be the top of a tool box. The location of the fastener installation sites 9 may be configured to meet the mounting needs of a particular truck. The fastener installation sites 9 are sized to allow fasteners (not shown) such as screws, cap screws, rivets or other types of fasteners to penetrate the installation sites 9. Though the fastener installation sites 9 may be configured to accommodate many types of fasteners, ¼ to ⅜ inch screws are often used.

In practice, the upper band 2 and lower band 3 may be sized to receive 2-10-gallon beverage containers. Most often it is sized to accommodate a 5-gallon beverage container 20 with a length and width of 13.5 inches and a height of 20.25 inches.

In practice as shown in FIG. 1, the holder 10 may have cup holder fastener installation sites 8 for the purpose of mounting a cup holder (not shown and not a feature of the invention) to the holder 10 so that cups are conveniently located near the beverage container 20.

The foregoing merely illustrates the principles of the invention. It will be appreciated that those skilled in the art will be able to devise numerous alternative arrangements that while not shown or described herein, embody the principles of the invention and thus are within its spirit and scope.

What is claimed:

1. A beverage container holder for mounting to the exterior of a vehicle comprising
A mounting plate,
A cage with an open top configured to receive and retain a beverage container;
One or more arms, at least one arm connecting the mounting plate to the cage, wherein the cage is offset from the mounting plate.

2. A beverage container holder for mounting to the exterior of a vehicle according to claim 1, wherein the holder is steel.

3. A beverage container holder for mounting to the exterior of a vehicle according to claim 2, wherein the steel is at least 3/16 inch thick.

4. A beverage container holder for mounting to the exterior of a vehicle according to claim 2, wherein the cage, arms, and base is constructed with straps of at least a 1 inch width.

5. A beverage container holder for mounting to the exterior of a vehicle according to claim 1, wherein the cage has a base with one or more fastener installation sites.

6. A beverage container holder for mounting to the exterior of a vehicle according to claim 1, wherein the cage is shorter than a beverage container.

7. A beverage container holder for mounting to the exterior of a vehicle according to claim 1, wherein the mounting plate has one or more fastener installation sites.

8. A beverage container holder for mounting to the exterior of a vehicle comprising
A cage comprising
Two or more bands, an upper band and a lower, both band having an interior area large enough to receive a beverage container and small enough such that a beverage container maintains an upright position, the upper band and the lower band are situated on the vertical axis such that a beverage container is restrained within the bands.
Two or more supports for connecting the upper band and the lower band, wherein at least one support is fixedly joined to the upper band and the lower band;
A mounting plate;
A base fixedly joined to one or more sides of the cage for engaging a bottom of a beverage container; and
One or more arms, at least one arm connecting the mounting plate to one side of the cage such that the mounting plate is offset from the cage.

9. A beverage container holder for mounting to the exterior of a vehicle according to claim 8, wherein the holder is steel.

10. A beverage container holder for mounting to the exterior of a vehicle according to claim 9, wherein the steel is at least 3/16 inch thick.

11. A beverage container holder for mounting to the exterior of a vehicle according to claim 9, wherein the cage, the arms, and the base is constructed with straps of at least a 1 inch width.

12. A beverage container holder for mounting to the exterior of a vehicle according to claim 8, wherein one or more arms are joined to the upper band portion of the cage and one or more arms are joined to the lower band portion of the cage for connecting the cage to the mounting plate.

13. A beverage container holder for mounting to the exterior of a vehicle according to claim 8, wherein the base and mounting plate have fastener installation sites.
